(19) United States
(12) Patent Application Publication
(10) Pub. No.: US 2009/0035211 A1
(43) Pub. Date: Feb. 5, 2009

(54) DEVICE FOR ENERGETICALLY UTILIZING SOLID WASTE

(76) Inventors: Hans Jorg Lafontaine, Sarreguemines (FR); Klaus Thomas Hildesheim, Sarreguemines (FR)

Correspondence Address: COLLARD & ROE, P.C., 1077 NORTHERN BOULEVARD, ROSLYN, NY, 11576, US

(21) Appl. No.: 12/086,540

(22) PCT Filed: Dec. 12, 2006
(86) PCT No.: PCT/IB2006/003576

§ 371 Date: Aug. 4, 2008

(30) Foreign Application Priority Data
Dec. 16, 2005 (DE) 202005019846.3

(51) Int. Cl. C01B 31/02

(52) U.S. Cl. 423/461; 422/232

(57) ABSTRACT

The invention relates to a device for energetically utilizing solid waste. The term “solid waste” refers, for example, to waste paper, scrap wood, plastic waste, production waste, industrial sludge or other solid fractions containing combustible constituents, or mixtures thereof. The aim of the invention is to create a device for thermally utilizing solid waste, which has a neutral if not even positive energy balance and is suitable for a wide range of waste materials while paying special attention to environmental relevance, especially the flue-gas composition. The aim is achieved by providing the inventive device with a material-feed mechanism, a charring apparatus and a thermal post-combustion apparatus. These basic components make it possible to utilize many different types of solid waste, the feedstock initially being transformed into hot gas which can be converted into steam and power as required.

The invention relates to a device for energetically utilizing solid waste.

The term “solid waste” refers, for example, to waste paper, scrap wood, plastic waste, production waste, industrial sludge or other solid fractions containing combustible constituents, or mixtures thereof.

Admittedly, devices for the energetic utilization of solid waste are known, but as a rule these have serious shortcomings. In most cases, for example, they are unable to optimally utilize the energy contained in the waste due to their size and a practically uncontrollable mixture of substances in the material fed into the plant. Moreover, the waste has to be heated to relatively high temperatures in order to ensure that burnout efficiency meets statutory requirements. As a result, considerable quantities of pollutants are liberated via the flue gas, which then has to be subjected to very time-consuming and costly scrubbing. Most such devices, furthermore, are configured for the utilization of solid waste with a calorific value exceeding 11,000 kJ/kg, which is not a pre-requisite for the invention described here.

From the EP 1 012 503 B1 and the DE 44 08 654 A1, for example, a device is known which is intended for the processing of solid waste materials, preferably garbage. On no account may these materials constitute waste requiring special supervision, as defined by European waste-disposal legislation, because no measures whatsoever have been taken to reduce or contain the pollutants generated during charring and incineration.

The DE 43 02 740 A1 describes a low-temperature carbonization plant in which the carbonizing process is carried out under oxygen deficit and the thermal energy required for carbonizing is generated by partial combustion of the material to be carbonized. The waste materials that can be processed by the technology described here may on no account be subject to special supervision as defined by European waste-disposal legislation (the surplus sludge fraction is spread on fields).

The DE 41 15 435 C1 describes a technology which serves exclusively for treating explosive materials. The process is operated in combination with or parallel with existing wastewater treatment plants and therefore is not a self-contained solution.

The process according to the WO 01/53510 A1 comprises a first stage involving aerobic fermentation, i.e. a composting stage during which material conversion is effected while air is supplied. During the second stage the organic material is carbonized. The carbonizing process is carried out under oxygen deficit in a low-temperature carbonizing plant, the thermal energy required for carbonization being generated by partial combustion of the material to be carbonized. During the third stage of the process, methane gas is generated from the low-temperature carbonization gas (=wood gas) under anaerobic thermophilic conditions.

The DE 10 2004 002 388 A1 describes a process for the energetic utilization of refuse-derived fuels and a pyrolysis plant for refuse-derived fuels. This process involves combined pyrolysis and fluidized-bed combustion exclusively of refuse-derived fuel in order to supplement existing coal-fired power plants, in which the pyrolysis gas is co-combusted.

The DE 694 10 841 T2 describes a discontinuously operating chamber-type pyrolysis reactor.

The DE 689 08 890 T2 describes a combination of a drum dryer with a separate drum thermolysis conducted in the absence of air under pressurized inert gas. The thermal energy needed for drying and thermolysis is generated by burning the cleaned thermolysis gas. Operation is of the batch type.

The DE 692 04 389 T2 describes a process and an installation for the thermolysis of industrial and household waste in the form of a downsteam washing stage for removing halogens from the thermolysis residues originating from the installation according to the DE 689 08 890 T2.

The object of this invention is to provide a continuously operating device for the thermal utilization of solid waste, which has a neutral if not even positive energy balance and is suitable for a wide range of waste materials while paying special attention to environmental relevance, especially the flue-gas composition.

This object is established according to the invention by providing the device with a material-feed mechanism, a charring apparatus and a thermal post-combustion apparatus.

These basic components make it possible to utilize many different types of solid waste, the feedstock initially being transformed into hot gas which can be converted into steam and electrical power as required.

The material-feed mechanism serves to uniformly charge the conveyor belt passing through the charring apparatus and to provisionally store previously shredded or crushed input material.

In the charring apparatus, organic fractions contained in the waste are converted into low-temperature carbonization gas.

After passing through the drying and charring zones, the material is transferred by the conveyor device to the incineration zone. Here, under controlled conditions, the coke is combusted at low temperatures with an excess of atmospheric oxygen.

An embodiment of the invention consists in that means for reducing the residual moisture content of the solid waste to be processed are provided in a drying zone.

In this connection it is advantageous that the means for reducing the residual moisture content include thermal radiators, in particular thermal radiators that can be heated with flue gas.

This drying step, which preferably takes place in the first third of the charring apparatus, ensures complete carbonization of the input material.

It is additionally useful that means are provided for adding an adsorber to the solid waste.

The preferably solid adsorber serves to bind the acidic gaseous pollutants during charring and incineration.

An embodiment of the invention consists in that the thermal post-combustion apparatus is an eddy-current combustor which is preferably provided with auxiliary burners.

The eddy-current combustor with its auxiliary burners is for heating up and ensuring that the required minimum combustion temperatures are reached.

This thermal post-combustion apparatus serves firstly to utilize the low-temperature carbonization gas, which has a high calorific value, and secondly to reliably destroy the gaseous pollutants contained therein. This setup simultaneously ensures that the flue gases remain in the hot zone for the minimum required period.

It is within the scope of the invention that the device has an incinerator and an ash-discharge system.

The discharged ash is transferred to a storage container.

It is furthermore useful that means are provided for drawing off the vapors from the drying zone, the low-temperature carbonization gas from the charring zone and/or the flue gas from the incinerator.

It is additionally useful that means are provided for conveying these extracted gaseous components, said means preferably having a hot-air fan.

The three gaseous components mentioned are preferably conveyed to the thermal post-combustion apparatus by way of a common hot-gas fan. This step is especially advantageous because the unpleasant smell of the highly malodorous vapours generated during the drying process is counteracted in this way.

Ultimately, it is also within the scope of the invention that means are provided for conveying flue gas from the thermal post-combustion apparatus to a heat-uptake device, preferably a waste-heat boiler.

On account of the nature of the solid waste used, the flue gas entering the waste-heat boiler has a sufficient energy content. In this waste-heat boiler, the energy content of the flue gas is then used to generate steam, which is preferably converted into power by means of a turbogenerator. The surplus electrical energy may be fed into the regional medium-high-voltage grid via a transformer station. Surplus heat energy may be supplied to neighbouring facilities by means of a short-distance heating network.

In this connection, it is useful that the flue-gas transport means include means for scrubbing the flue gas.

The invention is explained below in detail by reference to an embodiment.

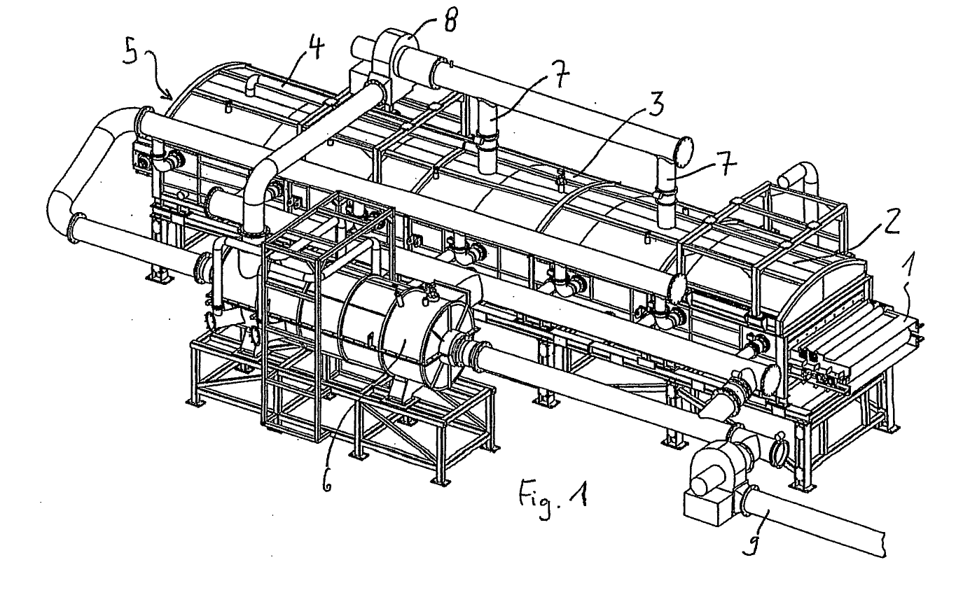

FIG. 1 is a schematic representation of a device according to the invention.

The solid waste materials, which are either delivered by external suppliers or generated by other facilities at the site of the invention, is crushed by a shredder and fed to one or more waste containers equipped with a belt feeder. For storage purposes and for blending/standardizing the input, the waste may be stored provisionally in receptacles or special areas provided for this purpose.

In the waste container provided with a belt feeder, the crushed waste is mixed with an adsorber material and then supplied to the device of the invention via a material-feed unit 1 configured as a conveyor belt with the width of the charring zone. The loosely packed input material is transferred to the heat-stable conveyor device and then passes through a dryer 2 which contains flue-gas-heated thermal radiators as a means of reducing the residual moisture content of the solid waste to be processed.

The waste subsequently passes through the charring apparatus 3, in which a substoichiometric oxygen atmosphere prevails.

The energy needed for drying and charring is taken from the flow of flue gas coming from the post-combustion apparatus.

The semicoke thus produced is ignited in the incinerator 4 in an excess of atmosphericx oxygen and is burned on the heat-stable conveyor device. Immediately downstream thereof an ash-discharge system 5 is located.

In this embodiment, the material-feed unit 1, the dryer 2, the charring apparatus 3, the incinerator 4 and the ash-discharge system 5 are installed within a closed housing as successive units through which the heat-stable conveyor device passes, and may be designated as a tunnel furnace. In conformity with this arrangement, the waste introduced in the material-feed unit passes successively through a drying zone 2, a charring zone 3 and an incineration zone 4.

Means for extracting the vapors from the drying zone, the low-temperature carbonization gas from the charring zone and/or the flue gas from the incineration zone are provided, as well as means for conveying the extracted gaseous components from the extracting means to a thermal post-combustion apparatus, the three above-mentioned gaseous components being passed over a means configured as a hot-gas fan 7 for conveying the extracted gaseous components.

The condensed vapours enter the thermal post-combustion apparatus 6, which is located in a separate housing in this embodiment, together with the low-temperature carbonization gases and the flue gases from the incinerator. In this embodiment, the post-combustion device 6 is engineered as an eddy-current combustor equipped with auxiliary burners.

The thermal post-combustion apparatus 6 also serves to indirectly heat the drying and charring zones. To this end, the flue gas is passed closely over the input material via a separately controllable piping system. If the calorific value of the low-temperature carbonization gas is inadequate, the necessary temperatures may be upheld by means of an auxiliary combustion system comprising two separately controllable burners.

Additionally, means 9 are provided for conveying flue gas from the thermal post-combustion apparatus 6 to a waste-heat boiler, said means also including means to scrub the flue gas.

After passing through the piping system for indirect heating, the cooled flue gas is heated once more in the thermal post-combustion apparatus. It may either serve as a heat source in industrial processes, or be used to generate superheated steam in a waste-heat boiler. If the superheated steam is then used to drive a turbogenerator, the excess electrical energy may be fed into the regional electricity grid by means of a dedicated transformer station. Surplus heat energy may be supplied to neighbouring facilities by means of a dedicated short-distance heating network or a steam line.

On account of the device being a closed assembly, it is possible to operate the device under negative pressure, thus counteracting any undesirable gas leakage from the device.

The charring apparatus is preferably controlled via a stored-program controller (SPC) connected up to a host computer with a visual display unit. The apparatus is operated from user terminals. All the equipment can be centrally controlled, and the parameters for the control circuits set, on the schematic representation of the device. All process and error messages, as well as signals from the measuring sensors, are displayed here. The SPC's host computer evaluates these signals and controls the electrical equipment as a function thereof.

A connection via the telephone network makes it possible to monitor and control the device via an external computer that is likewise equipped with a visual display unit. Critical operating parameters and error messages are sent by SMS to a continuously staffed station, thus ensuring permanent monitoring of sensitive and safety-relevant device components.

Under normal circumstances, the device is operated with an external power supply. With twin-configured installations that include power generation, the device is operated as a self-sufficient system. In this case there is also waste-processing redundancy, so that as a rule, failure of one part of the installation does not cause the process to be discontinued.

In emergencies, a battery-backed UPS unit powers the process computer until the normal power supply is continued again in a defined state. For the start-up phase, the device uses natural gas/heating oil and electric current from the public grid.

1-11. (canceled)

12. Device for continuous energetic utilization of solid waste, wherein the device has a material-feed mechanism (1), a drying zone (2), a charring zone (3), an incineration zone (4) and a thermal post-combustion apparatus (6), the material-feed mechanism (1), the dryer (2), the charring apparatus (3), the incinerator (4) and/or the ash-discharge system (5) being engineered within a closed housing as units through which a heat-stable conveyor device passes, and means (7) being provided for extracting the vapors from the drying zone (2), the low-temperature carbonization gas from the charring zone (3) and/or the flue gas from the incineration zone (4), as well as means (8) for conveying said extracted gaseous components, and thermal radiators that can be heated with flue gas via a controllable pipe system being provided in the drying zone (2) and in the charring zone, and auxiliary burners being provided in the post-combustion apparatus (6).

13. Device according to claim 12, wherein the means are provided for adding an adsorber to the solid waste.

14. Device according to claim 12, wherein the thermal post-combustion apparatus (6) is an eddy-current combustor.

15. Device according to claim 12, wherein the device includes an ash-discharge system (5).

16. Device according to claim 12, wherein the means (8) for conveying the extracted gaseous components comprises a hot-gas fan (8).

17. Device according to claim 12, wherein means (9) are provided for conveying flue gas from the thermal post-combustion apparatus (6) to a heat-uptake device, in particular a waste-heat boiler.

18. Device according to claim 17, wherein the means (9) for conveying the flue gas also include means to scrub the flue gas.

19. Process for operating a device according to claim 12, wherein the waste passes through the charring apparatus (3) in a substoichiometric oxygen atmosphere.

20. Process according to claim 19, wherein the semicoke produced is ignited in the incinerator (4) in an excess of atmospheric oxygen and is burned on the heat-stable conveyor device.
